(19) United States
(12) Patent Application Publication
(10) Pub. No.: US 2025/0297654 A1
(43) Pub. Date: Sep. 25, 2025

(54) ELECTRIC DISC BRAKE ACTUATOR WITH VIBRATION-DAMPED DIFFERENTIAL REDUCTION GEAR, COMPONENTS, BRAKE AND ASSEMBLY METHOD

(71) Applicant: HITACHI ASTEMO FRANCE, Drancy (FR)

(72) Inventors: Philippe BOURLON, Dammartin en Goële (FR); Cyril CUBIZOLLES, Drancy (FR)

(21) Appl. No.: 18/863,491

(22) PCT Filed: May 4, 2023
(86) PCT No.: PCT/EP2023/061841

§ 371 Date: Nov. 6, 2024

(30) Foreign Application Priority Data
May 13, 2022 (FR) FR2204585

(51) Int. Cl. F16D 65/18; F16D 65/00; F16D 121/24; F16D 125/40; F16D 125/50

(52) U.S. Cl. CPC F16D 65/18; F16D 65/0006; F16D 2121/24; F16D 2125/40; F16D 2125/50

(57) ABSTRACT

A rotary drive reduction gear within an electric brake actuator includes one or more planetary gear sets parallel or coaxial to a linear actuation direction, which are provided with at least one rotationally fixed ring gear. The reduction gear has an elastomeric damping device, which is arranged around the fixed ring gear and compressed radially and/or axially between the fixed ring gear and a brake housing. The reduction gear is a differential planetary gearset driven by a sun gear with planet gears meshing simultaneously with the fixed ring gear and a movable ring gear. The latter drives the nut of a reversible screw-nut mechanism, which produces a linear force. The overall irreversibility is produced by the differential gearset. Also provided is a component determined for producing the damper of this reduction gear, to a motor unit including this damper, to a brake and to a method for assembling same.

The invention relates to a rotary drive reduction gear or geared motor within an electric brake actuator. It comprises one or more planetary gear sets parallel and/or coaxial to the linear actuation direction, which are provided with at least one rotationally fixed ring gear.

This reduction gear further comprises a damping device made at least partially of an elastomer material, which is arranged around said fixed ring gear and compressed radially and/or axially between the fixed ring gear and a brake housing, thus providing radial and/or axial vibration damping therebetween.

Typically, the reduction gear is a differential planetary gear set driven by its sun gear with planet gears meshing simultaneously with the fixed ring gear and a movable ring gear. The latter drives the nut of a reversible screw-nut mechanism, which produces the linear force. The overall irreversibility is produced by the differential gearset.

The invention also relates to a component determined for producing the damper of this reduction gear, to a motor unit including this damper, to a brake and to a method for assembling same.

### PRIOR ART

Various reduction gear and geared motor architectures have been proposed for electric brake actuators, particularly for road vehicles, especially light automobiles and commercial vehicles.

To provide the linear force required to apply the brake pad, it is often proposed to use a reduction gear comprising one or more planetary gear sets, driven by a conventional rotary electric motor, for example a brushless DC motor or brush contacts. Such planetary gear sets comprise at least one central sun gear driving planet gears which rotate around it and mesh both with the sun gear and with the internal teeth of a ring gear.

For example, they are driven on the input side by the sun gear, while the planet gears are supported on a fixed ring gear to provide rotation on the output side by a planet carrier.

In some configurations, for example in document U.S. Pat. No. 4,804,073, the same group of planet gears meshes simultaneously with a fixed ring gear and a movable ring gear, which have a different number of teeth from one another. As a result of this difference, the output rotation of the movable ring gear is very high. In this document, the motor is end-mounted, coaxial with the differential reduction gear.

In other documents, such as document FR2999257A1 for example, the motor axis is parallel to and laterally offset from the output of the reduction gear.

However, these architectures have limitations and drawbacks in several respects, for example with their large axial or lateral dimensions, which can make them difficult to integrate into a vehicle. Furthermore, the vibrations created in the geared motor are a source of noise and wear that can be detrimental to comfort and reliability.

In FR3053422, it was proposed to add an external damper to the motor cover or geared motor housing. This type of solution does, however, have its drawbacks, in terms of complexity and size, and even in terms of assembly and fragility in use.

One aim of the invention is to overcome all or some of the drawbacks of the prior art. In particular, the aim is to minimize brake noise and wear due to vibration, while limiting size, fragility, integration and adaptation flexibility, manufacturing or assembly complexity, or to optimize the available compromises between these factors.

Also known from EP 2 824 354 is a rotary reduction gear or geared motor device within an electric brake actuator effecting linear displacement of a brake piston, said device being integrated into a brake housing and comprising one or more epicyclic trains parallel or coaxial to the linear actuation direction which use at least one ring gear fixed in rotation relative to said brake housing, comprising a damping device made at least in part from elastomer material and arranged around the primary transmission.

### PRESENTATION OF THE INVENTION

The invention provides a rotary drive reduction gear or geared motor device within an electric brake actuator effecting linear displacement of a brake piston, said device being integrated into a brake housing or intended to be assembled on such a brake housing, wherein: said device comprises one or more planetary gear sets parallel or coaxial to the linear actuation direction, which use at least one ring gear that is fixed against rotation relative to said brake housing.

According to the invention, this device comprises:
a damping device
at least partly made of elastomer material,
which is arranged around said fixed ring gear or intended to be so arranged, so as to be compressed radially and/or axially between said fixed ring gear and said brake housing, and
thus providing radial and/or axial vibration damping between said fixed ring gear and said brake housing.

According to a particular feature, the inner and/or outer surface of the damping device carries one or more radially projecting peripheral ribs which are radially compressed once in place, in particular each of which has continuity over the entire periphery so as to produce an axial seal.

According to another feature, the damping device comprises a cylindrical sleeve, typically circular, surrounding the fixed ring gear or its support, and which has an axial bearing flange A1, A2 at one end of said cylinder or at both its ends, so as to be axially compressed between said fixed ring gear and said brake housing.

More particularly, at least one axial bearing flange A1 has, on its outer surface, one or more lips A11, A12, A31 and A32 extending at least axially, in particular with continuity over the entire periphery, so as to produce a radial seal.

Optionally, the damping device comprises an inner reinforcement embedded in the elastomer and having a rigidity and/or elasticity greater than that of the elastomer, in particular a metal reinforcement.

According to yet another feature, the fixed ring gear is held against rotation by a motor housing, which alone directly or indirectly carries an electric motor driving the reduction gear, which motor housing forms an insert which is connected to the brake housing so as to compress the damping device.

According to one family of preferred embodiments, the device according to the invention comprises a so-called differential planetary reduction gear which is coaxial with the motor and which is driven at the input by a sun gear, which drives a group of planet gears, each of which meshes with both the fixed ring gear and a movable ring gear, which ring gears have different numbers of teeth from one another. On the output side, this movable ring gear rotates a screw-nut mechanism, in particular a reversible one, which produces a linear drive of a brake piston between a retracted position and an extended position, so as to exert a linear pressure in a so-called forward direction to produce a clamping force on a disc between clamping pads.

According to an advantageous feature, the differential planetary reduction gear rotates a reversible screw-nut mechanism, which transforms said rotation into a linear displacement applied to the brake piston.

According to another advantageous feature, the ring gear of the differential planetary reduction gear rotates the nut of the screw-nut mechanism, which is held against translation by a shoulder formed in a recess of the caliper housing, while its screw is held immobile against rotation by the brake piston, and is thus driven in translation by the rotation of said nut.

According to other aspects, the invention further proposes:

A damping device arranged to produce the damping device of a reduction gear or geared motor device as described herein.

A geared motor device for a brake actuator, characterized in that it comprises a reduction gear or geared motor device as described herein.

A disc brake for a road vehicle, in particular of the sliding or floating type for a road vehicle or motor vehicle, characterized in that it comprises a reduction gear or geared motor device as described herein.

Still according to another aspect, the invention proposes a method for assembling a brake for a vehicle, in particular a road vehicle, characterized in that it comprises:
mounting an electric motor carrying a sun gear shaft on a motor housing, thus forming a motor unit, or providing such a motor unit; and
assembling the motor housing of said motor unit on the brake housing,
by interconnecting one or more parallel or coaxial planetary gear sets to form a reduction gear as shown here, the fixed ring gear of which is held against rotation by said motor housing,
so that the damping device is compressed radially and/or axially between said brake housing and the fixed ring gear or its support.

In particular, the invention enables a reduction in the noise and wear caused in the rigid structure of the brake caliper by the operation of an electric planetary gear set. It is particularly relevant in the case of such a differential reduction gear, which allows compactness and high force and stroke capacity, while facilitating assembly and/or maintenance.

### BRIEF DESCRIPTION OF THE DRAWINGS

Other features and advantages shall become evident from the detailed description of an entirely non-limiting embodiment, and from the enclosed drawings, wherein:

FIG. 1 is a scaled view in longitudinal cross section showing a sliding disc brake caliper with electric actuator using the damping device of FIG. 3, shown without the motor cover and electronics, according to an example of an embodiment with the input pinion on a motor shaft mounted in the stator;

FIG. 2 is a scaled view in longitudinal cross section, showing a sliding disc brake caliper with electric actuator using the damping device of FIG. 3, according to a variant of the example of FIG. 1, with a motor housing fitted around the caliper housing recess;

FIG. 3 is a scaled longitudinal cross sectional view of the damping device used in an example embodiment of the invention,

FIG. 4 is a longitudinal cross sectional diagram showing the kinematics and distribution of the main parts of the actuator shown in FIG. 2;

FIG. 5 is an isometry with partial removal of the geared motor from FIG. 2, shown without the motor cover and electronics;

FIG. 6 is a longitudinal cross sectional diagram showing the kinematics of an actuator and the distribution of the main parts, according to a variant of the example shown in FIG. 4 wherein the rotor is mounted on an external bearing;

FIG. 7 is a longitudinal cross sectional diagram showing the kinematics of an actuator and the distribution of the main parts, according to a variant of the example in FIG. 6 wherein the rotor bearing and the fixed ring gear are mounted on the same tube, which forms a common centering element that is assembled with the motor housing, for example;

FIG. 8 is an isometric view showing a disc brake according to the example shown in FIG. 2, FIG. 4 and FIG. 5, or in FIG. 7 or FIG. 8;

FIG. 9 is a perspective exploded view, to scale, showing an example of the assembly of the actuator shown in FIG. 2 and FIG. 4 to FIG. 8.

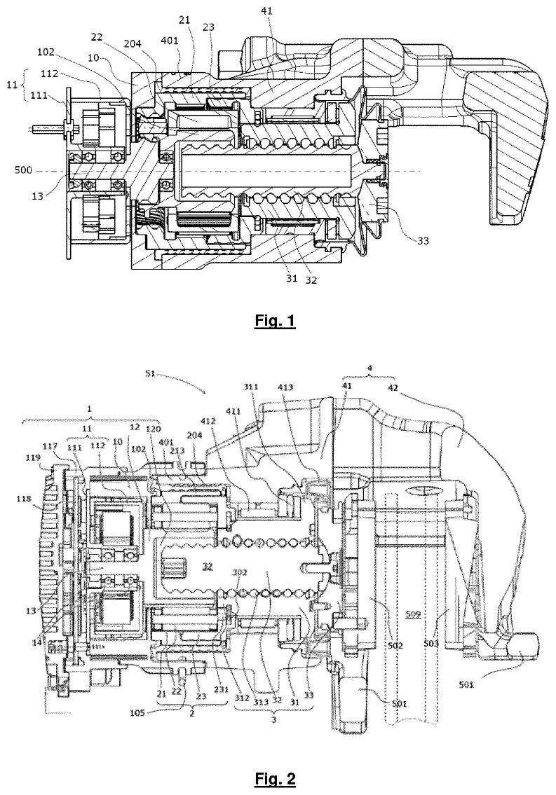

### DETAILED DESCRIPTION OF EMBODIMENTS

The examples of embodiments presented here are applied to electric actuators of sliding disc brake calipers, where the reduction gear is of the differential epicyclic type, with planet gears meshing both on a fixed ring gear and on a movable ring gear, which drives the nut of a reversible screw-nut mechanism made with a ball screw 313.

However, the invention is also intended to be applied to non-reversible screw-nut assemblies, or to non-differential planetary gear sets comprising at least one fixed ring gear. The fixed ring gear damping device is then mounted in a similar way and/or with adaptations accessible to the skilled person.

### First Embodiment

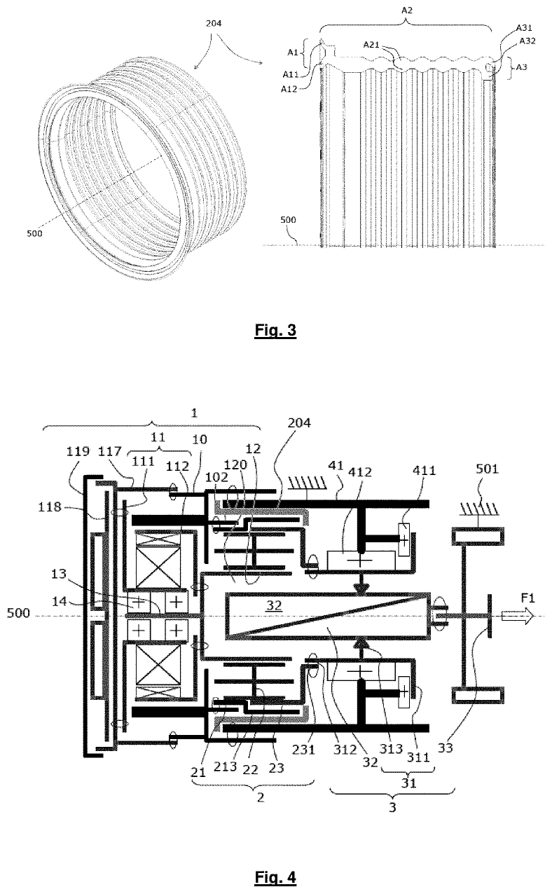

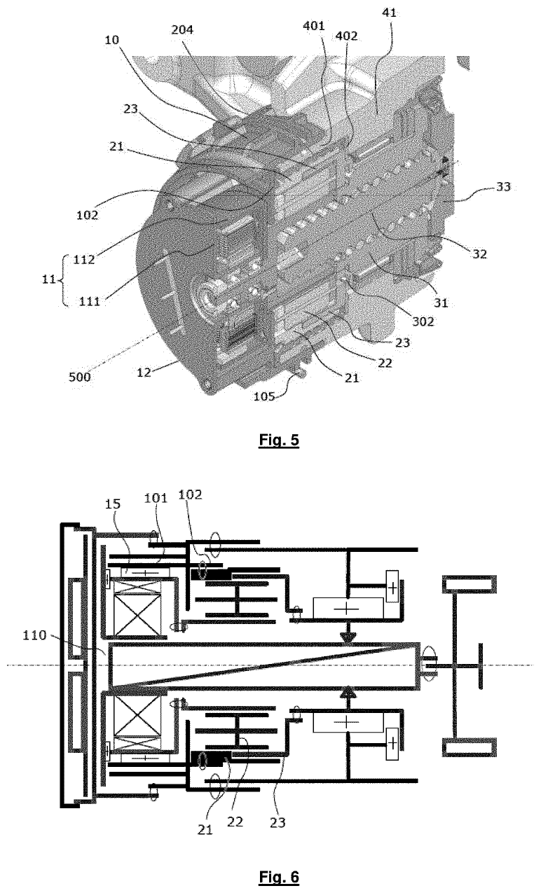

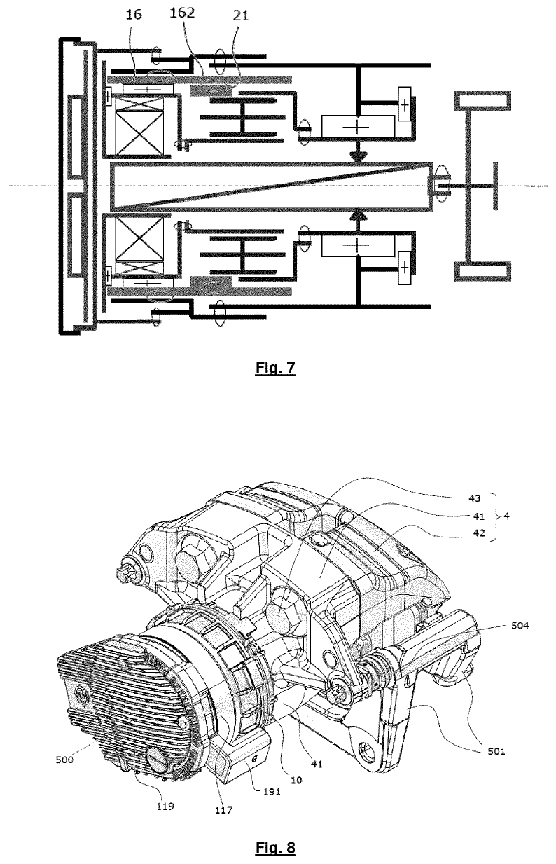

FIG. 2 to FIG. 9 show examples of floating caliper disc brakes with electric actuators, wherein the input sun gear is secured to a shaft 13 mounted in the stator of a motor 11.

The kinematics and construction of the example of FIG. 2 are shown by the diagram in FIG. 4. The kinematics of the example in FIG. 2 also conform to the diagram in FIG. 4.

In the example of FIG. 2 and FIG. 4, the motor 1 is of the type with an inner stator 111 and an outer rotor 112, or “out-runner,” here by way of example a DC motor with permanent magnets in the stator and magnetic windings in the stator. However, other known motor types are also available, such as the conventional out-runner type.

The rotor 112 is secured to an input sun gear 12, which comprises a shaft 13 that is guided in rotation by rolling bearings 14 mounted inside the tubular part of the stator 111.

The fixed ring gear 21 is attached to the motor housing 10, here by fitting inside a skirt 102 projecting axially from the motor housing on the front side. In this example, the fit is tight and anti-rotation is achieved by cooperating shapes, in this case axial protrusions 211, which protrude from the fixed ring gear and cooperate with voids in the skirt 102. Once the assembly has been assembled, the fixed ring gear 21 is fitted into a bore at the entrance to the brake housing recess 410.

The input sun gear 12 meshes with a group of planet gears 22, which are held in cages of a planet carrier ring 220.

These planet gears 22 are long enough to mesh with both the fixed ring gear 21 and a movable ring gear 23, which is coaxial and axially offset with respect to said fixed ring gear. In this example, the fixed ring gear 21 and the movable ring gear 23 have the same inner diameter and both have a modulus compatible with the teeth of the satellites, which are identical over the entire length of the satellites.

In this example, the movable ring gear 23 is guided in rotation, for example by lubricated friction, inside a skirt 213 which projects axially from the fixed ring gear 21 and is coaxial therewith.

The movable ring gear 23 has a number of teeth which differs from the fixed ring gear 21 by a small number of teeth, for example 4 to 5. It meshes with the planet gears 22, which are supported on the fixed ring gear 21, in this case with the same toothing, so that the movable ring gear 23 is driven in rotation by said planet gears at a very low speed compared to the speed of the input sun gear 12.

In this example, the motor 11 is attached in the motor housing 10, which is distinct from the caliper housing 41. The motor housing 10 has an axial skirt which extends toward the front side, and fits around a part 401 of the brake housing 41 which forms a sleeve extending from the rear side. This interlocking between skirt and sleeve 401 secures the motor housing 10 to the caliper housing 41, here with anti-rotation engagement and translational retention by an external circlip 105.

The stator 111 of the motor 11 is clamped between a shoulder of the motor housing 10 and a shoulder of an intermediate cover 117, which also carries an electronic board 118 that controls the motor and integrates power electronics supplying the windings. This intermediate cover 117 is closed at its rear end by a cover 119 forming a thermal radiator with the outside air, to evacuate the heat emitted by the electronic board 118 via fins. This radiator cover 119, for example made of die-cast aluminum alloy, is in contact with the hot components of the electronic board 118, typically via a thermally conductive paste.

The fixed ring gear 21 is arranged in a bore inside the sleeve 401 which surrounds the brake housing recess 410. The fixed ring gear is held radially by a radially damped cylindrical damper 204. This damper is made of an elastomer material, the cylindrical part of which has a plurality of circumferential ribs, which are compressed between the bore of the recess 410 and the surface of the skirt 213 of the fixed ring gear 21, providing sealing and radial damping.

On the front side, the end of the damper 204 extends radially inwards through an annular constriction which is interposed between the front end of the fixed ring gear 21 and a shoulder of the recess 410 of the caliper housing 41. Advantageously, this annular constriction has concentric lips, here toward the front, which are compressed to contribute to sealing and axial damping.

On the rear side, the end of the damper 204 extends radially outwards through an annular flange which is interposed between the rear end of the sleeve 401 of the caliper housing 41 and an annular groove of the motor housing 10. Advantageously, this annular flange has concentric lips, here toward the rear, which are compressed to contribute to sealing and axial damping.

In this example, lips A31 and A32 of the front bearing flange A3 bear on a sliding washer 402, which is free to rotate and bears axially on a shoulder formed in the caliper recess 410. The front end of the damping device 204 can also bear directly on such a shoulder.

In this way, the fixed ring gear 21 is held within the motor unit 1 by the motor housing 10, and the damper 204 provides damping to prevent direct transmission of vibrations from the ring gear and possibly the motor housing 10 to the caliper housing 41.

The movable ring gear 23 has a bore at the front which carries longitudinal grooves 231. They rotate the nut 31 of the screw-nut mechanism 3, through longitudinal grooves 312 that this nut 31 bears on its outer surface.

The nut 31 of the screw-nut mechanism is fixed against translation and is driven in rotation by the movable ring gear 23, and engages with the rotationally fixed screw 32 to move said screw in translation.

The rotation of the nut 31 thus produces a linear drive of the screw 32, in the tightening direction F1 or in the opposite withdrawal direction, depending on the direction of rotation of the motor.

The nut 31 is guided in rotation by a rolling bearing 412, in this case a roller bearing, mounted inside a bore 410 in the caliper housing 41. It is immobilized in axial translation, in the tightening direction, by abutment against an axial bearing face of a shoulder of the caliper housing 41 facing the front, by means of a roller bearing 411 arranged between this shoulder and a bearing flange 311 which surrounds the nut 32.

This screw 32 of the screw-nut mechanism 3 is secured to a support plate 33 acting as a brake piston, which transmits the linear actuation to at least one clamping pad 502, to produce a clamping force F1 on a disc 509 between clamping pads 502, 503.

The input sun gear 32 has an axial recess 120 which opens on the front side, and is designed to receive the screw 32 of the screw-nut mechanism 3 when in the retracted position (position shown in the figure).

The support plate 33 here is substantially disc-shaped and covers the engagement zone between the screw and the nut, in the sense that it projects radially beyond it. Here, it is surrounded by a bellows seal 413.

In the tightening direction, the piston plate 32 receives direct axial bearing from the screw 32 of the screw-nut mechanism. It is attached to the end of screw 32 by an axial fastener, in this case a central screw 333, which provides traction on the plate when the screw moves in the withdrawal direction. Rotational attachment is ensured by cooperation of an anti-rotation form 323 carried by the end of the screw 32 with a complementary form carried by the rear face of the piston plate 33. This in turn is held in rotation by anti-rotation notches 335. These are held fixed against rotation in a known manner by studs protruding from the rear face of the inner clamping pad 502, which in turn is held inside a bracket 501.

As will be understood, the damping sleeve 204 prevents vibrations produced at the fixed ring gear 21 from being transmitted directly to the sleeve 401 of the caliper housing 41, and limits the transmission of vibrations produced in the motor and upstream of the drivetrain.

It also allows this fixed ring gear 21 to naturally assume the centering position imposed thereupon by the motor housing 10, without being overly constrained by the surface finish or internal geometry of the caliper recess 410.

The radial ribs A21 and axial lips A11, A12, A31, A32 improve damping owing to their inherent elasticity and the deformation gaps surrounding them. They also help seal the caliper housing 41 from dust and fluids inside the epicyclic differential gear set.

In the example shown in FIG. 2, the motor housing 10 is mounted flat and axially supported on the caliper housing 41, on its rear face which surrounds its rear recess 410 accommodating the reduction gear 2, and secured by known means, for example. According to a particular feature, the motor housing 10 engages with the caliper housing 41 by means of centering means, for example of a known type.

### Second Embodiment

FIG. 6 shows a second example embodiment, which will only be described in terms of its differences.

In this example, the motor 11 is also of the out-runner type with outer rotor 112 and inner stator 111. Unlike the first disclosed example, this time the outer rotor is guided from the outside. It is mounted inside a roller or needle bearing 15, which in turn is mounted inside a bore of the motor housing 10 (recess 110). This feature is intended to be combined with the various variants described here for the rest of the actuator.

This guiding from the outside is rarely, if ever, used in this type of context, for example because the position of the bearing usually inside the motor limits the linear movement speed of the bearing parts relative to one another.

However, in spite of the additional radial space generated by the outer bearing in this example, this arrangement provides new advantages, particularly for this type of actuator. In fact, the space freed up in the center of the motor extends the travel of the screw 32 when it retracts, by extending the recess 120 created in the center of the sun gear 12.

Additionally, the choice of guiding the rotor from the outside improves the precision of its centering in relation to the centering support 101 formed for it by the motor housing 10, and therefore in relation to the fixed ring gear 21 which is secured to this motor housing (see also reference 162, corresponding to a common centering support part). This improved centering reduces manufacturing precision requirements and, for example, improves acoustic and wear performance, particularly for this type of differential reduction gear with two different ring gears mounted on common planet gears.

### Third Embodiment

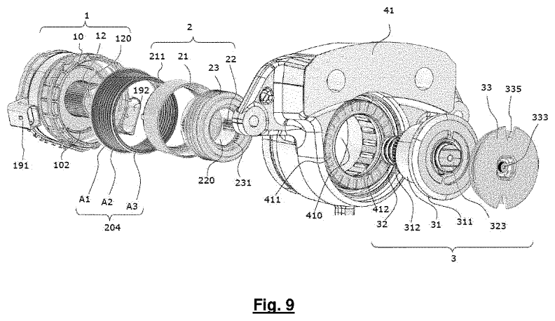

FIG. 9 shows a third example, which will only be described in terms of its differences from the second example.

In this third example, the motor is attached to the motor housing 10, via a common centering support 16 forming a separate part from said housing 10. This centering support is in this case a cylindrical tube, for example made of a material and/or with treatments giving it greater rigidity than is useful for the rest of the motor housing 10. In this example, the fixed ring gear 21 is fitted and attached to this centering support 16 (as indicated by the ovals on the figures), for example by press fitting. Alternatively, the ring gear can be cut directly from the centering support material.

Of course, the invention is not limited to the examples just described, and many adjustments can be made to these examples without going beyond the scope of the invention.

### Nomenclature

A1, A2 axial bearing flange
A3 front bearing flange
A11, A12, A31, A32 lips
1, motor unit
10 motor housing, motor housing as centering support
101 motor housing centering support for rotor bearing
102 motor housing skirt, centering support for fixed ring gear
105 assembly clip for mounting motor housing on caliper housing
11 motor
110 inner stator recess
111 stator
112 rotor
117 intermediate motor cover
118 electronic board
119 radiator cover
12 hollow sun gear
120 sun gear inner recess
13 sun gear shaft
14 sun gear shaft rolling bearings
15 outer guide rolling bearings of the rotor
16 centering support common to rotor and fixed ring gear
162 part of the common centering support, forming a fixed ring gear support
191 electrical connectors of the motor
2 epicyclic differential reduction gear
204 cylindrical damper
21 fixed ring gear
211 anti-rotation notches of the fixed ring gear
213 skirt of the fixed ring gear
22 planet gears
220 planetary carrier ring
23 movable ring gear
231 coupling splines for the movable ring gear
3 screw-nut mechanism
302 movable ring gear assembly circlip with nut of the screw-nut assembly
31 rotating nut
311 bearing flange of the nut
312 nut coupling grooves
313 balls of the screw-nut mechanism
32 screw fixed against rotation
323 rotational coupling form of the nut
33 support plate—brake piston
333 screw for attaching support plate to screw
335 anti-rotation notches of the piston support plate
4 caliper
401 caliper housing of the rear sleeve
402 sliding washer 402, freely rotating
41 brake housing, caliper housing
410 caliper housing of the rear recess
411 axial stop with rolling bearing
412 guide bearing with rolling bearing
413 piston dust seal
42 caliper nose, outer caliper arm
43 screws for assembling caliper nose to caliper housing
500 linear actuation direction
501 bracket
502 inner clamping pad
503 outer clamping pad
509 brake disc
51 brake (M1)
F1 clamping force

1. A rotary drive reduction gear or geared motor device within an electric brake actuator effecting linear displacement of a brake piston, said device being integrated into a brake housing or intended to be assembled on such a brake housing,
said device comprising: one or more planetary gear sets parallel or coaxial to the linear actuation direction;
which use at least one ring gear that is fixed against rotation relative to said brake housing;
a damping device made at least in part of elastomer material,
which is arranged around said fixed ring gear to be compressed radially and/or axially between said fixed ring gear and said brake housing; and
thus providing radial and/or axial vibration damping between said fixed ring gear and said brake housing.

2. The device according to claim 1, characterized in that the inner and/or outer surface of the damping device carries one or more peripheral ribs which are radially compressed once in place, in particular each of which has continuity over the entire periphery so as to produce an axial seal.

3. The device according to claim 1, characterized in that the damping device comprises a cylindrical sleeve surrounding the fixed ring gear or a support of the fixed ring gear, and which has an axial bearing flange at one end of said cylinder or at both its ends, so as to be axially compressed between said fixed ring gear and said brake housing.

4. The device according to the claim 3, characterized in that at least one axial bearing flange has, on its outer surface, one or more lips extending at least axially, in particular with continuity over the entire periphery, so as to produce a radial seal.

5. The device according to claim 1, characterized in that the damping device comprises an inner reinforcement embedded in the elastomer and having a rigidity and/or elasticity greater than that of the elastomer, in particular a metal reinforcement.

6. The device according to claim 1, characterized in that the fixed ring gear is held against rotation by a motor housing, which carries an electric motor driving the reduction gear, which motor housing forms an insert which is assembled to the brake housing so as to compress the damping device.

7. The device according to claim 1, characterized in that it comprises a differential planetary reduction gear, which is coaxial with the motor and which is driven at the input by a sun gear, which drives a group of planet gears, each of which meshes with both the fixed ring gear and a movable ring gear, which ring gears have different numbers of teeth from one another,
which movable ring gear rotates a screw-nut mechanism which produces a linear drive of a brake piston between a retracted position and an extended position,
so as to exert linear pressure in a forward direction to produce a clamping force on a disc between clamping pads.

8. The device according to claim 7, characterized in that the differential planetary reduction gear rotates a reversible screw-nut mechanism, which transforms said rotation into a linear displacement applied to the brake piston.

9. The device according to claim 7, characterized in that the movable ring gear of the planetary reduction gear rotates the nut of the screw-nut mechanism, which is held against translation by a shoulder formed in a recess of the caliper housing, while its screw is held immobile against rotation by the brake piston, and is thus driven in translation by the rotation of said nut.

10. A damping device arranged to produce the damping device of a reduction gear device according to claim 1, said damping device being made at least in part of elastomeric material and is arranged around a fixed ring gear of said reduction device so as to be compressed radially and/or axially between said fixed ring gear and a brake housing when said reduction gear device is integrated into said brake housing, said damping device thus providing radial and/or axial vibration damping between said fixed ring gear and said brake housing.

11. A geared motor device for a brake actuator, characterized in that it comprises a device according to claim 1.

12. A disc brake for a road vehicle, comprising a reduction gear or geared motor device according to claim 1.

13. A method for assembling a brake for a vehicle, characterized in that it comprises:
mounting an electric motor carrying a sun gear shaft on a motor housing, thus forming a motor unit, or providing such a motor unit; and
assembling the motor housing of said motor unit on the brake housing;
by interconnecting one or more parallel or coaxial planetary gear sets to form a reduction gear according to claim 1, the fixed ring gear of which is held against rotation by said motor housing;
so that the damping device is compressed radially and/or axially between said brake housing and the fixed ring gear or its support.
